(19) United States
(12) Patent Application Publication
(10) Pub. No.: US 2009/0235244 A1
(43) Pub. Date: Sep. 17, 2009

(54) SOFTWARE UPDATE SYSTEM FOR INFORMATION EQUIPMENT

(76) Inventors: Ikumi Enomori, Kawasaki (JP); Satoshi Hasegawa, Yokohama (JP)

Correspondence Address: MATTINGLY & MALUR, P.C., 1800 DIAGONAL ROAD, SUITE 370, ALEXANDRIA, VA, 22314, US

(21) Appl. No.: 12/365,915

(22) Filed: Feb. 5, 2009

(30) Foreign Application Priority Data
Mar. 12, 2008 (JP) 2008-062001

(51) Int. Cl. G06F 9/44

(52) U.S. Cl. 717/170

(57) ABSTRACT

A software update system includes a first server resided in a network different from a home network and has a storage device to store a software to be used for information equipment, and a second server resided in a network different from the home network and has an information equipment control unit that requests a software version to the information equipment, and a service control unit that requests a software version to the first server and compares the software version acquired from the information equipment with the software version acquired from the first server, which uniformly manages the information equipment by an internet service provider (ISP), in which ISP uses a standardized DHCP scheme and MAC address as an inherent value to identify the information appliance such that a user's operational burden can be reduced by using a TV monitor, a cellular telephone, etc. as a user interface.

### INCORPORATION BY REFERENCE

The present application claims priority from Japanese application JP 2008-062001 filed on Mar. 12, 2008, the content which is hereby incorporated by reference into this application.

### BACKGROUND OF THE INVENTION

The present invention relates to a software update system and a server for managing the system which updates a software incorporated in an information appliance through a network.

Recently, there have been developed information appliances to be connected through a LAN, including consumer electronics such as TV sets, DVD recorders, refrigerators, rice cookers, etc. These information appliances are designed such that they are operated by using a software incorporated in a device in advance. In this way, a new function can be added to the information appliance and a software bug can be eliminated by updating the software.

In the case of updating the software for the information appliances, it is necessary that a user must have a technological knowledge since the user directly operates the respective information appliances, contacts to a vendor server for each of the information appliances, and also requires a download and an install of that software. Further, in the case where a vendor or maker is different for each of the information appliances, it is sometimes necessary to use a different update method for each of these appliances. Furthermore, it is necessary to update the software at every newly purchased information appliance, which makes the user compel a burden of work.

JP-A-2005-135187 has proposed a software update method of the information appliances. However, there is a problem that an exclusively use server must be installed at a home to control the information appliances resided in a home.

### SUMMARY OF THE INVENTION

In light of the current technique, an object of the invention is to provide a software update system for information equipment, including information appliances, capable of firstly updating a software incorporated in the information appliance without installing a specialized device such as an information appliance control server at a user, secondly standardizing and simplifying user interfaces of the software update processing for the information appliances, regardless of the types of information appliances, and thirdly simplifying the operation of the software processing for the information appliances and providing means for the user, for confirming updated contents of the software.

The software update system is provided for the information equipment, including information appliances, connected with a home network. The software update system includes a first server that is resided in a network different from the home network and provided with a storage device to store a software to be used for the information equipment. The software update system further includes a second server that is resided in a network different from the home network, and provided with an information equipment control unit that requests a software version to the information equipment that stores a software, and a service control unit that requests a software version to the first server that stores the software version and compares the software version acquired from the information equipment with the software version acquired from the first server.

According to the invention, the user can update the software to be used for the information appliances without installing a specialized or exclusively use server at a home.

The other objects, features and advantages of the invention will become apparent from the following description of the embodiments of the invention taken in conjunction with the accompanying drawings.

### BRIEF DESCRIPTION OF THE DRAWINGS

FIG. 1A is a block diagram showing a software update system in one embodiment of the invention;

FIG. 1B is a block diagram showing a user terminal in FIG. 1A;

FIG. 1C is a block diagram showing an information appliance in FIG. 1A;

FIG. 2A is a diagram showing a user basic information database;

FIG. 2B is a diagram showing a DHCP server using database;

FIG. 2C is a diagram showing a product list database;

FIG. 2D is a diagram showing a user identification database;

FIG. 2E is a diagram showing a software management database;

FIG. 2F is a diagram showing a vendor server using software management database;

FIG. 3 is an example of a sequence diagram in the software update;

FIG. 4A is a flowchart showing an operation of the software update;

FIG. 4B is a flowchart showing an operation of the software update; and

FIG. 5 is a screen transition diagram showing a user terminal for use in a software update processing.

### DESCRIPTION OF THE INVENTION

Hereinafter, embodiments of the invention will be described with reference to the drawings.

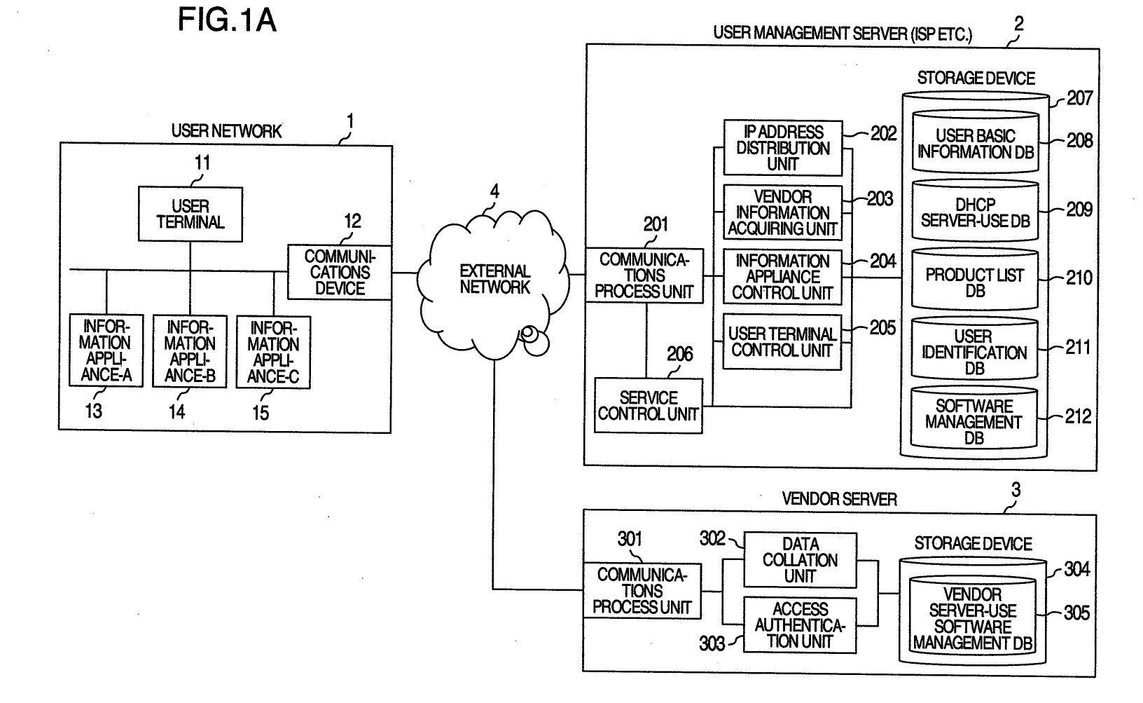

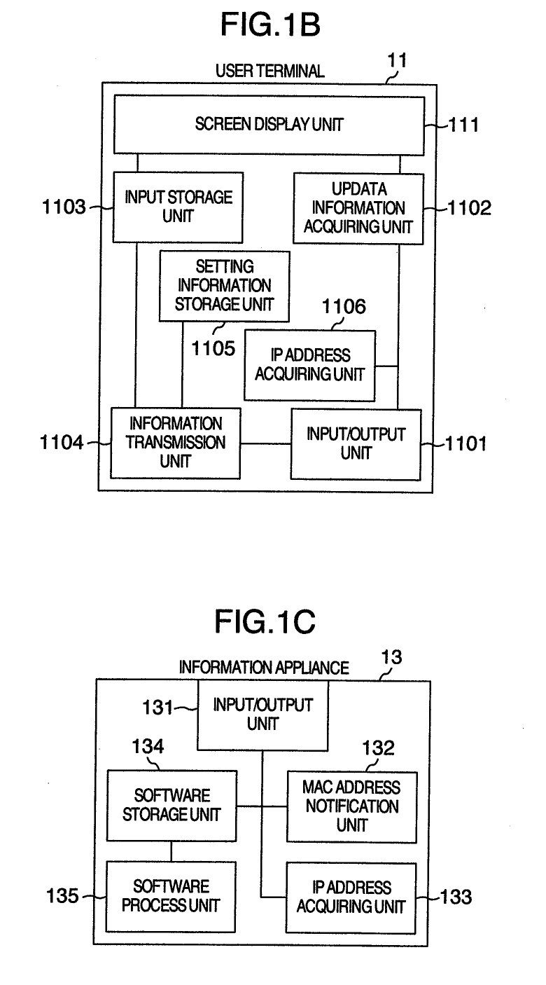

FIG. 1A is a system constitution diagram relative to a software update system for information appliances. FIG. 1B is a detailed constitution diagram showing a user terminal. FIG. 1C is a detailed constitution diagram showing an information appliance. A user network 1 included in a user's home, a user management server 2 and a vendor server 3, are connected with each other via an external network 4. The user network 1 has a LAN environment which connects an information appliance-A 13, an information appliance-B 14 and an information appliance-C 15 each resided in a home, with the external network 4. That is, the user management server 2 and vendor server 3 are resided in a different network environment from the respective information appliances-A 13, -B 14 and -C 15 via the external network 4.

The information appliances-A 13, -B 14 and -C 15 correspond to a refrigerator, a TV set, etc. These can be communicated with a network communications system installed at the home. The user network 1 has a communications device 12 at a connection part connected with the external network 4. The communications device 12 may be acceptable of any types if it has a network communications function to be able to communicate with external network devices, such as a home gateway server, a router, etc. Further, the user network 1 provides a user terminal 11 which is operated by the user. The user terminal 11 may be acceptable of any types if it can display information on such a generally use personal computer, a network-use TV monitor, etc. The user terminal 11 outputs an update permission notification or a cancel notification when it receives a software update notification from the user management server 2. The user terminal 11 also transmits an authentication key for a software downloaded to the user management server 2 when the software update is permitted. Alternatively, the user terminal 11 may command to the information appliances-A 13, -B 14, -C 15 to transmit the authentication keys in the respective information appliances to the user management server 2.

The vendor server 3 stores an update-use software for the information appliances.

The user management server 2 manages the user terminal 11 and the information appliances for every user network 1 and updates the software present in the information appliances. The user management server 2 serves as an internet service provider which relays a connection from the respective homes to the external network 4. The user management server 2 receives respectively software versions from the information appliances-A 13, -B 14, -C 15 in the user network 1, also receives a latest software version from the vendor server 3 storing a software corresponding to the information appliance, and compares the software version from the information appliance with the latest software version.

For example, the user management server 2 points out the information appliance-A 13 which should install the latest software version. The user management server 2 then notifies a software update, which indicates that the update is necessary, to the user terminal 11 in the user network 1 to which the same network as the information appliance-A 13 belonged, and then executes an update processing permitted by the user. As a result of the foregoing processing, the user does not require to pay attention to different types of information appliances. Further, the user terminal 11 and the information appliances may only be communicated with the user management server 2, so that the update processing can be executed without paying attention even to every difference of vendors by the user. The update is certainly notified to the user terminal 11, so that the update processing for the information appliance can be executed by acquiring the permission from the user. Furthermore, the user can also confirm that which software is downloaded.

Function blocks of the user management server 2 will be described with reference to FIG. 1A. The user management server 2 includes a communications process unit 201 to be communicated with the communications device 12 and vendor server 3, and an IP address distribution unit 202 having a function of automatically allotting necessary information such as an IP address to a communications device to be temporarily connected. In the case of this embodiment, the user terminal 11 and information appliances-A 13, -B 14 and -C 15 correspond to the temporarily connecting communications equipment. The user management server 2 also includes a vendor information acquiring unit 203 to acquire software information from the vendor server 3, an information appliance control unit 204 to execute the software update for the information appliance, a user terminal control unit 205 to execute a communications processing with the user terminal 11, and a storage device 207 having a plurality of databases to execute the software update of the information appliances resided in the user network 1.

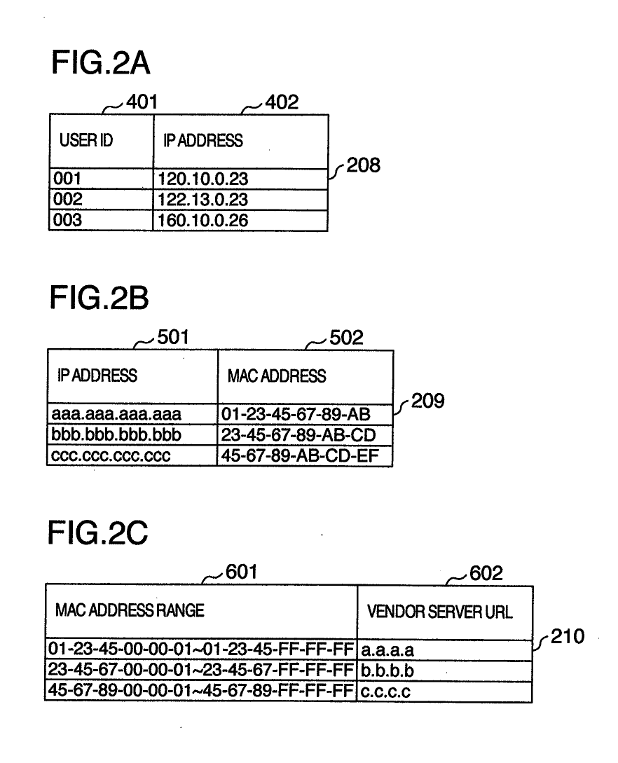

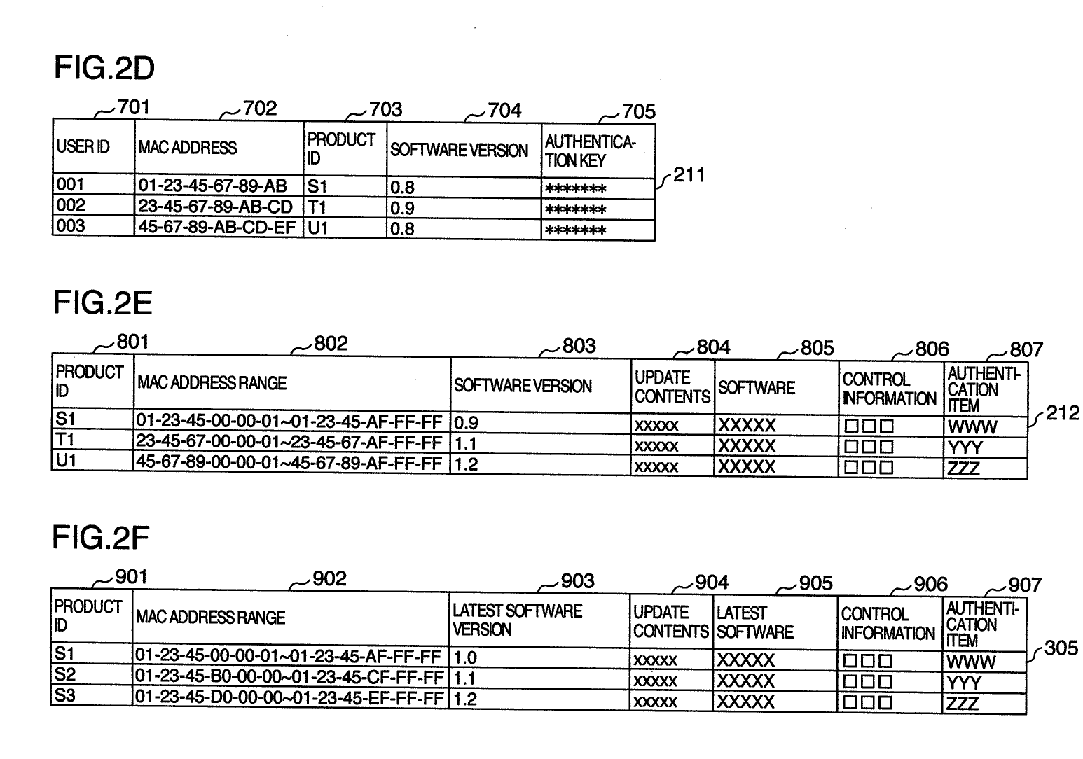

The respective databases contained in the storage device 207 will be described with use of FIGS. 2A to 2F. A user basic information database 208 is used for managing a user ID for notifying information to the user and an IP address of the user to be communicated, and stores a user ID 401 to be allotted to the user terminal 11 and an IP address 402 of the user terminal 11 corresponding to the user ID 401, as shown in FIG. 2A.

A DHCP server-use database 209 manages the IP address to be allotted to which of equipment, when the IP address distribution unit 202 distributes the IP address to the respective equipment, at a time when the user terminal 11 and information appliances-A 13, -B 14 and -C 15 are connected to the external network 4. As shown in FIG. 2B, the DHCP server-use database 209 stores a correspondence of an allotted IP address 501 and a MAC address 502 of the respective information appliances.

A product list database 210 manages such that the software to be updated to the information appliance is resided in which of the vendor servers 3. As shown in FIG. 2C, the product list database 210 stores a MAC address range 601 being allotted to the respective products and a vendor server URL 602 storing a software used for the product having the MAC address in a range of the MAC address range 601. The MAC address means a physical address of an inherent hardware in a network equipment, which is represented by 48 bits in which a first 24-bit is allotted to a network equipment manufacturer and a last 24-bit is allotted independently to the respective manufacturers such that they are not duplicated with each other. In fact, a vendor can be identified by checking the first 24-bit, and a product by checking the last 24-bit. Normally, the respective vendors allot a predetermined range of the last 24-bit to a specific product.

Specifically, the following description will be concerned with a case where a vendor “A” allotted with the first 24-bit “01-23-45” as the MAC address is connected to the user network 1. In the case where a user purchases a “TV set made by A” as a product of “A”, the user turns on a switch of the user terminal 11 to activate the user network 1. The MAC address “01-23-45-22-34-21” as “TV set made by A” is transmitted to the user management server 2. The user management server 2 compares the received MAC address “01-23-45-22-34-21” with the MAC address range 601 in the product list database 210. The MAC address “01-23-45-22-34-21” belongs to the MAC address range “01-23-45-00-00-01 to 01-23-45-FF-FF-FF” present in the first record of the product list database 210. Therefore, an update-use software for the “TV set made by A” is discriminated such that it is held in a server indicating URL “aaa.aaa.aaa.aaa”.

As an identifier of the information appliance in the user management server 2, there are used a scheme of DHCP (Dynamic Host Configuration Protocol) normally used for an external network connection and the MAC address as a value of an inherent equipment. For this reason, a constitution of the user side is not physically changed. In addition, it is necessary to set a correspondence of the MAC address range 601 and the vendor server URL 602 by a system manager, in advance.

A user identification database 211 manages such that each of the users holds which of the products (information appliance) and whether the software version is latest. As shown in FIG. 2D, the user identification database 211 stores a user ID 701 corresponding to the user basic information database 208, a MAC address 702 of the information appliance held by the user which is indicated by the user ID 701, a product ID 703 indicating a model number of the product, a software version 704 of the information appliance, and an authentication key 705 necessary for acquiring the software from the vendor server 3. The authentication key 705 is information for proving the user who is a right person, by entering such character string from the user. The authentication key 705 may be allotted with every user or every product, or may also be entered only at a time of a first update of the information appliance.

A software management database 212 stores necessary information for every product at a time of updating the software of the respective information appliances. As shown in FIG. 2E, the software management database 212 stores a product ID 801 corresponding to the user identification database 211, a MAC address range 802 allotted to the product indicated by the product ID 801, a presently holding software version 803, presently holding software update contents 804, a presently holding software 805, a control information 806 for absorbing differences of the update processing in every product of the information appliances and every vendor, and an authentication item 807 relative to items which require an entering from the user at a time of the software update.

Next, the following description will be concerned with function blocks in the vendor server 3. The vendor server 3 includes a communications process unit 301 to communicate with the user management server 2 via the external network 4, a storage device 304 containing a vendor server-use software management database 305 which stores information relative to the software to be used for the information appliances, a data collation unit 302 for incorporating the operation of the vendor server-use software management database 305 with the user management server 2 on the update processing of the information appliance, and an access authentication unit 303 for authenticating that whether the user has a right authority to update the software.

The vendor server-use software management database 305 manages the update-use software managed by the vendor server 3 for every product ID corresponding to the software management database 212. As shown in FIG. 2F, the vendor server-use software management database 305 stores a product ID 901 corresponding to the product ID in the software management database 212, a MAC address range 902 allotted to the product indicated by the product ID 901, latest software version information 903, update contents 904, a latest software 905, control information 906, and an authentication item 907.

Next, the following description will be concerned with function blocks in the user terminal 11 with use of FIG. 1B. The user terminal 11 includes an input/output unit 1101 to communicate with the user management server 2 via the external network 4, an update information acquiring unit 1102 to store the update notification received from the user management server 2, a screen display unit 111 to display an operation screen relative to the update notification stored in the update information acquiring unit 1102, an input storage unit 1103 to store information entered by the user in accordance with an indication on the operation screen, an information transmission unit 1104 to transmit data of the input storage unit 1103 and a setting information storage unit 1105 to the user management server 2, the setting information storage unit 1105 to store the user ID to be used for a registration processing for receiving an update service from the user management server 2 and the MAC address of the user terminal 11, and an IP address acquiring unit 1106 to acquire the distributed IP address. In addition, it is necessary to set the user ID in the user terminal 11 in advance.

The following description will be concerned with function blocks in the information appliance-A 13 with use of FIG. 1C. The information appliances-B 14 and -C 15 have the same constitution as the information appliance-A 13. The information appliance A 13 includes an input/output unit 131 to communicate with the user management server 2 via the external network 4, a MAC address notification unit 132 to notify the MAC address to the user management server 2 since the distribution of IP address is received by causing DHCP when a power is turned on, an IP address acquiring unit 133 to acquire the distributed IP address, a software storage unit 134 to store the update-use software received from the user management server 2, and a software process unit 135 to execute the update processing by the update-use software stored in the software storage unit 134.

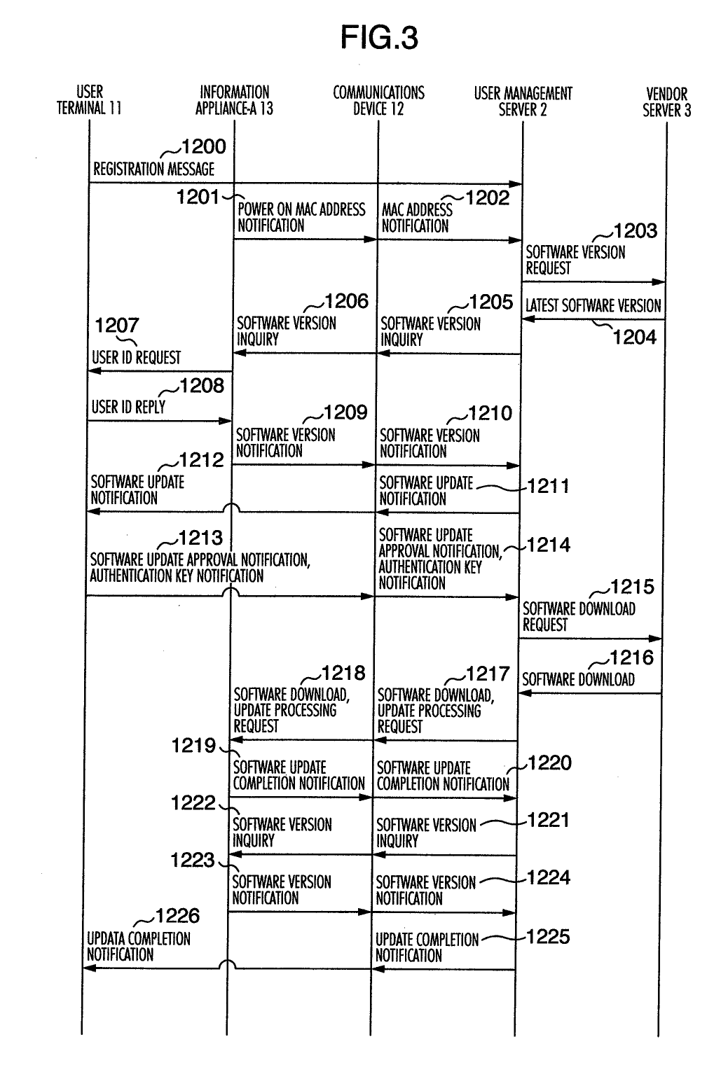

Next, the following description will be concerned with a sequence of the software update processing with use of FIG. 3, as an example, of the information appliance-A 13. An internally detailed operation of the respective equipment and servers will be described later.

In the user terminal 11 in FIG. 1B, the information transmission unit 104 transmits a registration message containing the user ID in the setting information storage unit 1105 and the MAC address of the user terminal 11 to the user management server 2, at a process 1200. When the power of the information appliance-A 13 in FIG. 1C is turned on, the MAC address notification unit 132 notifies the MAC address of the information appliance-A 13 to the user management server 2 via the communications device 12, at processes 1201 and 1202. In the user management server 2, the IP address distribution unit 202 distributes the IP address to both the user terminal 11 and information appliance-A 13 to connect to a network, and to make communicate with the other server, at the processes 1200 to 1202. In addition, it is necessary to set the IP address of the user management server 2 in the user terminal 11 and the respective information appliances in advance. Further, in the user management server 2, the user ID received from the user terminal 11 and the IP address distributed to the user terminal 11 are stored in the user basic information database 208, at the process 1200.

Next, the vendor server URL 602 and product ID 703 are extracted from the storage device 207 by using the received MAC address as a key, and the latest software version corresponding to the extracted product ID 703 is requested to the vendor server 3 indicated by the extracted vendor server URL 602, at a process 1203. The request of the latest software version at the process 1203 means that version information of the software corresponding to the product ID 703 held by the vendor server 3 is requested to the vendor server 3, for example, the version information such as a version “1. 0. 1” is requested to the vendor server 3.

In the vendor server 3 received the version request of the software, a software version corresponding to the received product ID 703 is extracted from the storage device 304, and then replied to the user management server 2, at a process 1204.

When the information appliance-A 13 newly approaches to the user network 1 to be intended to connect with the user management server 2 for the first time, the user management server 2 inquires the presently installed software version in the information appliance-A 13 for the information appliance-A 13 other than the process 1204, at processes 1205 and 1206. This is because there is no software information in the user identification database 211 in the case where the information appliance-A 13 is connected to the user management server 2 for the first time.

The information appliance-A 13 received the version request of the software requests a user ID to the user terminal 11, at processes 1207 and 1208. Thereafter, the acquired user ID and the software version notification are transmitted to the user management server 2, at processes 1209 and 1210. This is because the user ID should be associated with the MAC address of the information appliance to be newly registered, since the user management serve 2 cannot discriminate that information appliance for which of the users have transmitted from, in the case where the information appliance is connected to the user management server 2 for the first time.

The following description will be concerned with a case where an association is given to between the MAC address and the user ID when the information appliance-C 15 is newly registered. First, in the user management server 2, the MAC address “45-67-89-AB-CD-EF” of the information appliance-C 15 is acquired at the process 1202, and the user identification database 211 is referred, but there is no a corresponding user ID and software version, because of a new registration. For this reason, the user management server 2 acquires a user ID “003” and a present software version “0.8” of the information appliance-C 15 at the processes 1205 to 1210. A correspondence among the user ID “003”, the MAC address “45-67-89-AB-CD-EF”, and the present software version “0.8” of the information appliance-C 15, is stored in the user identification database 211. In addition, the foregoing processes 1203 and 1204, and processes 1205 to 1210, may be made back and forth in sequence.

Next, in the user management server 2, the software version from the vendor server 3, acquired from the process 1210, is compared with the software version of the information appliance-A 13. If the software version of the information appliance-A 13 is older than that of the vendor server 3, the software update notification is transmitted to the user terminal 11 resided in the user network 1 in which the information appliance A-13 is also resided, at processes 1211 and 1212.

The user terminal 11 received the software update notification displays a screen for confirming and operating the software update for the user on the screen display unit 111. The user enters an authentication key necessary for the update, and the user terminal 11 replies a software update approval notification (software update permission notification) containing the authentication key to the user management server 2, at processes 1213 and 1214, when the software update is approved.

After receiving the software update approval notification, the user management server 2 transmits, to the vendor server 3, a software download request containing the received authentication key and the product ID of the information appliance-A 13 to be updated, at a process 1215. In the vendor server 3 received the software download request, the received authentication key is authenticated by the access authentication unit 303. If it is confirmed that the user is right, the latest software corresponding to the received product ID, update contents, control information, and authentication item, are replied to the user management server 2, at a process 1216.

In the user management server 2 received the latest software, the update process request containing the latest software acquired at the process 1216, the update contents, the control information, and the authentication item, are transmitted to the information appliance-A 13 resided in the user network 1, at processes 1217 and 1218. The information appliance-A 13 carries out the update processing by executing the received latest software. The information appliance-A 13 transmits a software update completion notification to the user management server 2, when the update processing is completed, at processes 1219 and 1220.

The user management server 2 received the software update completion notification at the process 1220 inquiries the software version to the information appliance-A 13 which executed the update processing, for confirming that whether the update is executed normally, at processes 1221 and 1222. The information appliance-A 13 received the inquiry replies the present software version to the user management server 2, at processes 1223 and 1224. The user management server 2 confirms that the update processing of the information appliance-A 13 is completed normally in response to the reply, and then transmits the software update completion notification to the user terminal 11, at processes 1225 and 1226.

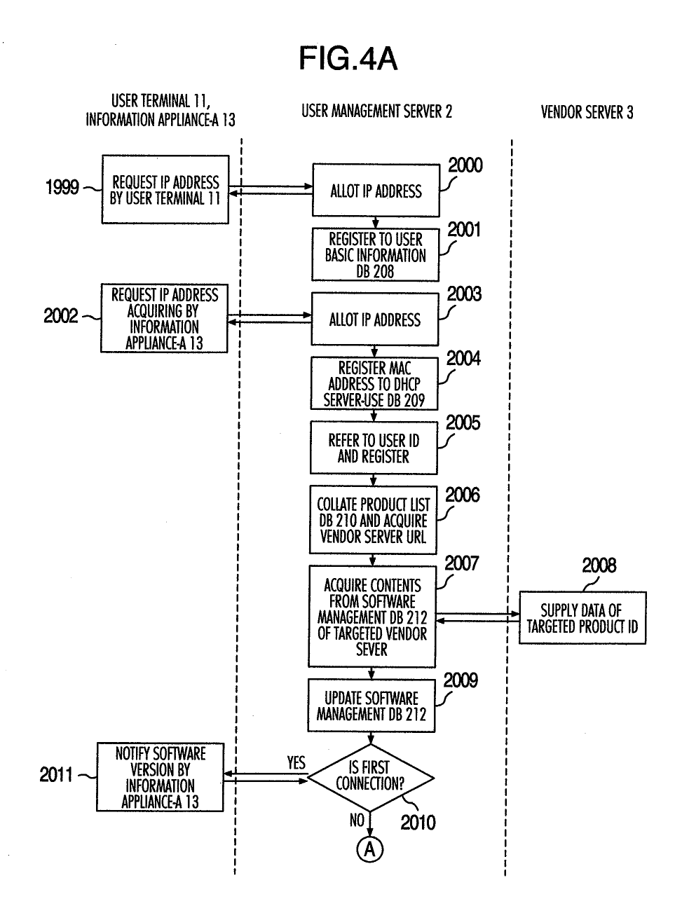

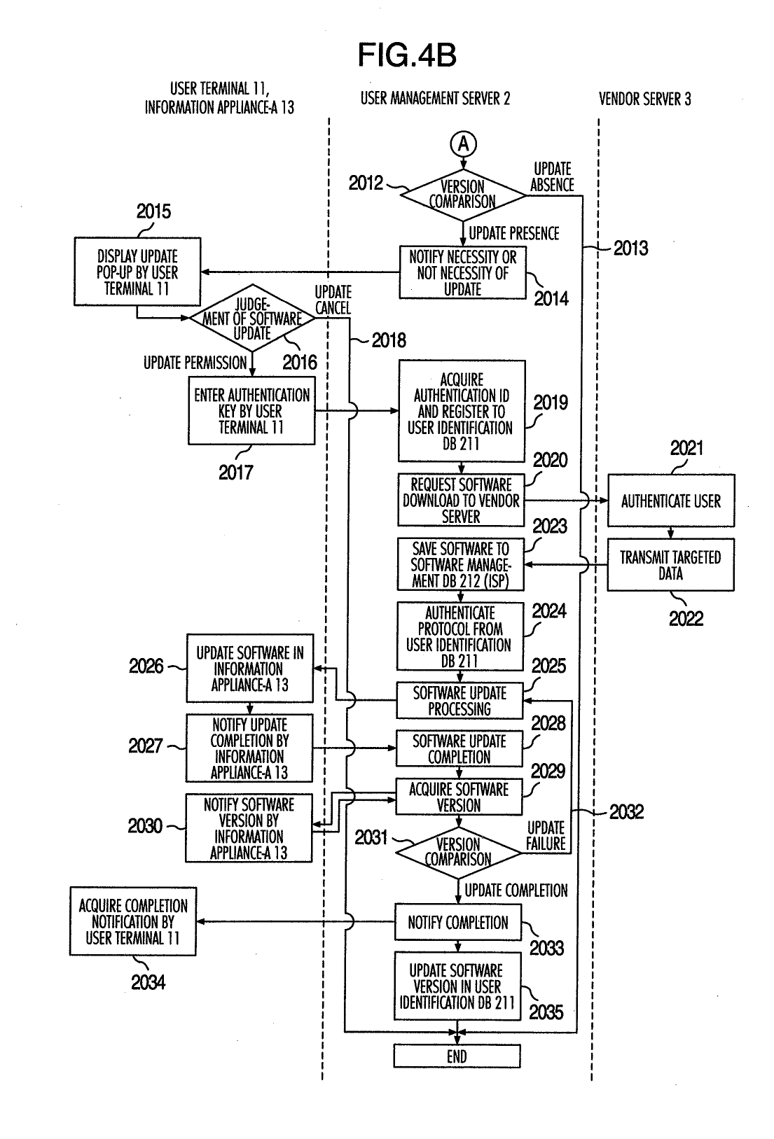

The above-mentioned description has been paid attention to a message of the respective equipment in the system such as information appliance-A 13 etc., and the following description will be concerned with an internal operation of the respective equipment in detail with use of FIGS. 4A and 4B.

Specifically, the following description will be concerned with a case where the information appliance-A 13 holding the MAC address “01-23-45-67-89-AB” resided in the user network 1 in which the user terminal 11 of the user ID “001” is also resided, are newly connected to the user management server 2. In the user terminal 11, for a purpose of receiving a registration subject to a service and an acceptance of the IP address, the information transmission unit 1104 extracts the MAC address and the user ID “001” itself from the setting information storage unit 1105 to transmit the registration message containing the MAC address and user ID “001” to the user management server 2 via the input/output unit 1101, at a step 1999. In addition, it is necessary to set the user ID and the IP address of the user management server 2 in the user terminal 11 in advance.

In the user management server 2, the communications process unit 201 receives the MAC address notification from the user terminal 11 to transmit the notified MAC address to the IP address distribution unit 202 by a service control unit 206. The IP address distribution unit 202 refers to the DHCP server-use database 209 to reply an empty IP address “120.10.0.23” to the user terminal 11 which received the MAC address notification and then store its correspondence or contents in the DHCP server-use database 209, at a step 2000. Further, the service control unit 206 refers to the user basic information database 208 by using the notified user ID “001” as a key and writes the given IP address “120.10.0.23” to a record of the corresponding user ID 401, at a step 2001. In this way, the IP address “120.10.0.23” is distributed to the user terminal 11 having the user ID “001” to be connected to the external network 4. In addition, in the user management server 2, the user basic information database 208 is referred by using the user ID “001” as a key to be able to notify information to the user terminal 11.

The information appliance-A 13 is turned on, and then transmits the MAC address “01-23-45-67-89-AB” to the user management server 2 by the MAC address notification unit 132 via the input/output unit 131, due to a reception of the IP address, at a step 2002.

In the user management server 2, the communications process unit 201 receives a notification of the MAC address “01-23-45-67-89-AB”, which is then sent to the IP address distribution unit 202 by the service control unit 206. The IP address distribution unit 202 refers to the DHCP server-use database 209 to reply an empty IP address “aaa.aaa.aaa.aaa” to the information appliance-A 13 which received the notification of MAC address “01-23-45-67-89-AB” at a step 2003.

The IP address distribution unit 202 makes store a correspondence of the MAC address “01-23-45-67-89-AB” and the IP address “aaa.aaa.aaa.aaa” in the DHCP server-use database 209, at a step 2004. In this way, the user management server 2 can be communicated with the information appliance-A 13 indicated by the MAC address “01-23-45-67-89-AB.” The service control unit 206 refers to the user identification database 211 by using the MAC address “01-23-45-67-89-AB” acquired at the step 2003 as a key to acquire the user ID and the product ID corresponding to the information appliance-A 13. In the case of example shown in FIGS. 4A and 4B, the information appliance-A 13 cannot acquire the user ID and the product ID since it is a newly connected appliance. After-mentioned steps 2010 and 2011 are then executed in the case of the newly connected appliance.

Next, the service control unit 206 refers to the software management database 212 by using the MAC address “01-23-45-67-89-AB” acquired at the step 2003 as a key to acquire the corresponding product ID “S1” and register it to the user identification database 211, at a step 2005.

The service control unit 206 then extracts a URL “a.a.a.a” of the corresponding vendor server 3 from the product list database 210 by using the MAC address “01-23-45-67-89-AB” acquired at the step 2003 as a key, at a step 2006. Next, the service control unit 206 inquires the latest software version corresponding to the product ID “S1” extracted at the step 2005, to the vendor server 3 indicated by the URL “a.a.a.a” extracted at the step 2006 via the communications process unit 201.

In the vendor server 3, the inquiry of the latest software version is sent to the data collation unit 302 via the communications process unit 301. The data collation unit 302 extracts the latest software version “1.0”, the update contents, the control information, and authentication item from the vendor server-use software management database 305 by using the received product ID “S1” as a key. The data collation unit 302 replies a response to the inquiry of the latest software version containing the extracted latest software version “1.0”, the update contents, control information, and authentication item to the user management server 2 via the communications process unit 301, at a step 2008.

In the user management server 2, the response to the inquiry of the latest software version is sent to the service control unit 206 via communications process unit 201. The service control unit 206 then refers to the software management database 212 by using the product ID “S1” used for the inquiry, as a key. A software version “0.9” stored in the software management database 212 is compared with the notified latest software version “1.0”. By judging that the notified latest software version is new, the software version 803, the update contents 804, the software 805, the control information 806, and the authentication item 807 in the software management database 212, are updated to the latest information received from the vendor server 3, at a step 2009. In this way, the user management server 2 can always provide the latest software by synchronism with the latest software resided in the vendor server 3 at every notification acquired from the information appliance.

Next, the service control unit 206 refers to the user identification database 211 by using the user ID “001” acquired at the step 2003 and the MAC address “01-23-45-67-89-AB” as a key to thereby acquire a presently resided software version “0.8”in the information appliance-A 13, at a step 2010. In addition, if the software version is not registered in the user identification database 211 or the information appliance-A 13 is firstly connected to the server, the information appliance control unit 204 requests to the information appliance-A 13 to acquire the software version on the basis of control information in the software management database 212 to then execute a step 2011. If the information appliance-A 13 is not firstly connected, the step 2011 is omitted, but a step 2012 is executed.

In the case of an example shown in FIG. 4A, the step 2011 is executed since the information appliance-A 13 is connected for the first time. In the user management server 2, the product ID is extracted by using the MAC address “01-23-45-67-89-AB” of the information appliance-A 13, acquired at the step 2003, as a key. The information appliance control unit 204 then requests the software version information to the information appliance-A 13 in the user management server 2.

The information appliance-A 13 receives the request for acquiring the software version via the input/output unit 131 to then request the user ID “001” to the user terminal 11. Next, the software process unit 135 relies the notification of the software version “0.8” being stored in the software storage unit 134 and the user ID “001” to the user terminal 11 via the input/output unit 131. In the user management server 2, the notification of the software version “0.8” and the user ID “001” are received via the communications process unit 201, and the service control unit 206 makes store the received user ID “001”, the MAC address “01-23-45-67-89-AB”, the product ID “S1”, and the correspondence of the software version “0.8” in the user identification database 211, at the step 2011.

The service control unit 206 then compares the presently resided software version “0.8” in the information appliance-A 13, acquired at the steps 2010 and 2012, with the latest software version “1.0”. In this case, a step 2014 and the subsequent steps are executed, at the step 2012, since the software version in the information appliance-A 13 is not latest. If the software version in the information appliance-A 13 is latest, an update processing is terminated, at a step 2013.

The service control unit 206 sends the software update request to the information appliance-A 13, to the user terminal control unit 205. The user terminal control unit 205 refers to the user basic information database 208 by using the user ID “001” acquired at the step 2005 as a key to acquire an IP address “120.10.0.23” of the user terminal 11, and then sends a software update notification containing the latest software version “1.0”, the update contents, authentication item to the user terminal 11 via the communications process unit 201, at a step 2014.

The software update notification is transmitted to the user terminal 11 via the communications device 12. In the user terminal 11, the software update notification received from the input/output unit 1101 is stored in the update information acquiring unit 1102, and the screen display unit 111 then notifies the update information to the user on the basis of the received authentication item, at a step 2015. The authentication item contains information indicating that the information appliance-A 13 requires an authentication key of the product and necessary information to be displayed on the screen. In the case of this embodiment, necessary input items are the authentication key and the update approval.

The user terminal 11 stands by at a state indicating that the authentication key and update approval are entered from the user, at a step 2016. The user terminal 11 accepts necessary information for the software update processing such as the authentication key and update approval from the user to then store the input contents in the input storage unit 1103, and the information transmission unit 1104 replies the update approval notification containing the entered authentication key to the user management server 2 via the input/output unit 1101, at a step 2017. In the user terminal 11, if the input indicating that the update processing is refused from the user is accepted at the step 2016, the subsequent steps are omitted, and the update processing is terminated at a process 2018.

In the user management server 2, the update processing notification is received via the communications process unit 201 to be then sent to the service control unit 206. The service control unit 206 makes store the received authentication key in the user identification database 211, at a step 2019. In addition, the input of the authentication key may be accepted only for the first time, and the second and subsequent steps may be unnecessary.

The service control unit 206 transmits a download request for the update-use software containing the authentication key, the software version “1.0”, and the product ID “S1” to the vendor server 3 of the URL “a.a.a.a” acquired at the step 2003 via the communications process unit 201, at a step 2020. In addition, it is also possible to download the update-use software other than the latest version by indicating a software version at the step 2016.

In the vendor server 3, the download request of the update-use software is notified to the access authentication unit 303 via the communications process unit 301. The access authentication unit 303 holds an authentication key list to be compared with the received authentication key, confirming that the user is right. The access authentication unit 303 outputs a download processing request to the data collation unit 302, at a step 2021, when the right user is discriminated.

The data collation unit 302 then extracts a targeted software from the vendor server-use software management database 305 by using the product ID “S1” and software version “1.0” as a key to reply to the user management server 2 via the communications process unit 301, at a step 2022.

In the user management server 2, the software received via the communications process unit 201 at the step 2022 is notified to the service control unit 206. The service control unit 206 sends the received software to the vendor information acquiring unit 203. The vendor information acquiring unit 203 makes store the received software in the software management database 212 to then notify it to the service control unit 206, at a step 2023.

Next, the service control unit 206 sends an update command for the information appliance-A 13 to the information appliance control unit 204. The information appliance control unit 204 extracts the software and control information from the software management database 212 by using the product ID “S1” acquired at the step 2005 as a key, at a step 2024. The information appliance control unit 204 then refers to the DHCP server-use database 209 by using the MAC address “01-23-45-67-89-AB” acquired at the step 2003 as a key to extract the IP address “aaa.aaa.aaa.aaa” of the information appliance-A 13, and then transmit the update information to the information appliance-A 13 via the communications process unit 201 on the basis of the control information acquired at the step 2024, at a step 2025.

In the information appliance-A 13, the update information received via the input/output unit 131 is stored in the software storage unit 134, and the update processing is executed by using the update information containing the stored software by the software process unit 135, at a step 2026. The software process unit 135 completes the software update to then reply a completion notification to the user management server 2 via the input/output unit 131, at a step 2027. In the user management server 2, the communications process unit 201 receives the completion notification at a step 2028 to be then sent to the service control unit 206. At this time, the software version of the information appliance-A 13 becomes the latest version “1.0”.

Likewise the sequence in the step 2010, an acquiring request of the software version is transmitted to the information appliance-A 13, at a step 2029. The information appliance-A 13 replies the present software version “1.0”, which is the same as the step 2011, at a step 2030. Likewise the step 2012, the service control unit 206 compares the software version in the information appliance-A 13 with the software version in the software management database 212, at a step 2031.

If the software version in the information appliance-A 13 is different from the software version in the software management database 212 at the step 2031, the service control unit 206 judges that the update is not normally executed to thereby send an update non-completion notification to the information appliance control unit 204. The information appliance control unit 204 makes the step return to a repetition processing at a step 2025, to execute the software update processing, at a process 2032. In the case of this processing, the software in the information appliance-A 13 is updated normally, therefore, a step 2033 is executed without executing the process 2032.

If the software version in the information appliance-A 13 is the same as that in the software management database 212 at the step 2031, the service control unit 206 judges that the update is normally executed, and then sends the update completion notification to the user terminal control unit 205. The user terminal control unit 205 transmits the update completion notification to the user terminal 11 via the communications process unit 201, at the step 2033.

The update completion notification is transferred to the user terminal 11 via the communications device 12. In the user terminal 11, the update completion notification is received from the input/output unit 1101 to be sent to the update information acquiring unit 1102. In the user terminal 11, the contents of the update completion notification stored in the update information acquiring unit 1102 are displayed on the screen display unit 111 to thereby notify the update completion to the user, at a step 2034.

In the user management server 2, the service control unit 206 makes adapt the software version “0.8” in the user identification database 211 to the updated software version “1.0” at a step 2035, after the processing of the step 2033. As described above, the update processing in series is terminated.

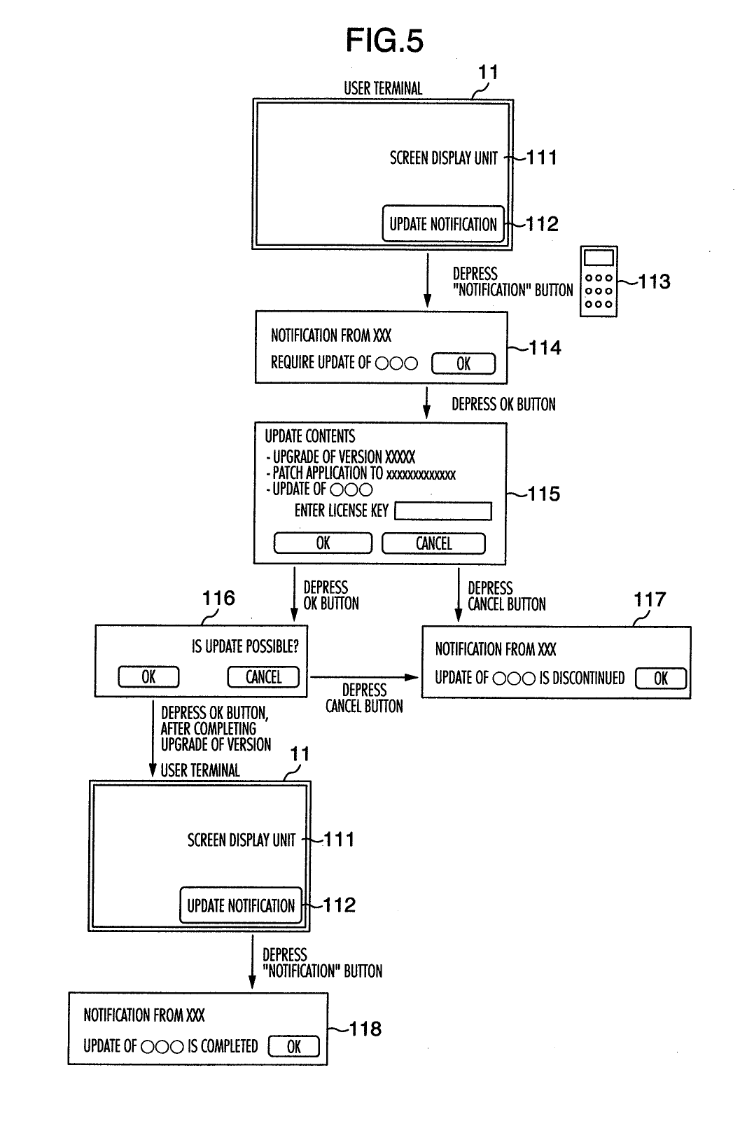

FIG. 5 shows an example of a screen transition to be notified to the user, at the step 2015 in FIG. 4B. FIG. 5 illustrates a case where the user terminal 11 is a network-use TV monitor. A personal computer or other equipment may also be used.

First, the update notification is notified from the user management server 2 to display an update notification button 112 on the screen display unit 111 in the user terminal 11. The user depresses a “notification” button on a remote controller 113 used for the TV monitor to display an update pop-up screen 114.

Next, an OK button on the update pop-up screen 114 is depressed to display an authentication key input screen 115, and stand by at a state indicating that the authentication key is entered from the user. Here, an input for selecting a cancel from the user is entered to display an update discontinuation notification screen 117, and the update processing is then terminated. An input for selecting OK from the user is entered to display a software update screen 116 as a finally confirming screen. After completing the update of software, the update notification button 112 is again displayed on the screen display unit 111, and the user depresses the “notification” button on the remote controller 113 to display an update completion notification screen 118.

In this way, a routinely used TV monitor, a cellular telephone, etc. are used for a user interface to be able to confirm that whether the necessity of software update can be determined by the simply remote operation and whether the software update can be indicated thereby.

In relation to the above-mentioned equipment in this embodiment, the vendor server 3 may be represented as an update data server or a first server since it stores the update-use software. The user management server 2 may be represented as an update server or a second server since it updates the software in the information appliance in place of the vendor server 3.

Further, the user network 1 may be represented as a home network since it is often installed in the user's home. The user terminal 11 may be represented as a terminal device since it is used for displaying the updated screen for the user. The information appliance may be represented as a network connectable information appliance including a personal computer etc., as an extensive meaning.

Likewise the foregoing reasons, the information appliance control unit 204 in the user management server 2 may be represented as an information equipment control unit. The user terminal control unit 205 in the user management server 2 may be represented as a terminal process unit.

Further, the communications process unit 201 in the user management server 2, the input/output unit 1101 in the user terminal 11, the input/output unit 131 in the information appliance-A 13, and the communications process unit 301 in the vendor server 3, are used for the communications processing, therefore, they may be represented as a first communications process unit, a second communications process unit, a third communications process unit, and a fourth communications process unit, respectively.

As described above, the user management server 2 resided in the external network 4 serves as an internet service provider (ISP) which relays to connect the homes with the external network 4, and also serves as a DHCP server capable of allotting the IP address when the information appliances for use in the homes carry out communications. The user management server 2 further uses the MAC address provided as information of the appliance itself, when the respective information appliances acquire the IP address, so that the information of the respective information appliances can be possessed in the database resided in the user management server 2 itself. In this way, the information appliance can communicate with the other servers, at the same time, the software information in the information appliance can be handled.

The respective information appliances collate the database at every connection to the network to inquire, whether the software update of the information appliances is required, to the vendor server 3 of the information appliance, so that the version information of the software can be confirmed. When the software should be updated, the software is once downloaded at the user management server 2 to be able to install in each information appliance by adapting with a control system of each information appliance. In this way, the software can be updated without paying attention to the difference of interfaces. The software is once downloaded from the vendor server 3 to be able to install a module transformed software from the user management server 2, without downloading from the vendor server 3, in the case of the same software version.

When the vendor server 3 receives the download request of the update software for use in the information appliance from the user management server 2, an information terminal such as the TV monitor or cellular telephone having communications means capable of two-way communications is used as an operation terminal for use in the homes, so that the software update can be executed with a simple operation of the remote controller by the user.

It should be further understood by those skilled in the art that although the foregoing description has been made on embodiments of the invention, the invention is not limited thereto and various changes and modifications may be made without departing from the spirit of the invention and the scope of the appended claims.

1. A software update system for information equipment connected with a home network, comprising:
a first server resided in a network different from the home network and having a storage device to store a software to be used for the information equipment, and
a second server resided in a network different from the home network and having an information equipment control unit that requests a software version to the information equipment that stores a software, and a service control unit that requests a software version to the first server that stores a software and compares the software version acquired from the information equipment with the software version acquired from the first server.

2. The system according to claim 1 further comprising,
the plurality of information equipment, and
a terminal device connected to the home network that connected with the information equipment to carry out an update operation for the plurality of information equipment, wherein
the second server includes a first communications process unit to carry out a communications processing with the terminal device, and
the first communications process unit transmits an update request of the information equipment to the terminal device, when the software version stored in the first server is newer than the software version stored in the information appliance.

3. The system according to claim 2 wherein
the terminal device includes a second communications process unit that transmits an update permission notification of the software in the information equipment to the second server, when an update permission is accepted from a user,
the service control unit in the second server transmits a software request message to the first server, when the software update permission notification is received from the terminal device, and
the information equipment control unit transmits the software to the information equipment, when a software to be used for the update is received from the first server.

4. The system according to claim 3 wherein
the software update permission notification transmitted by the second communications process unit includes an authentication key to confirm that whether the user is a right one entered together with the update permission.

5. The system according to claim 2 wherein
the information equipment provides a third communications process unit that transmits a MAC address allotted to the information equipment, to the second server,
the second server provides a user identification database to store a product list database to store the MAC address of the information equipment, a user identification database that store the MAC address of the information equipment and a product ID to identify a product model number of the information equipment corresponding to the MAC address, and a product list database that stores the MAC address of the information equipment and a URL of the first server corresponding to the MAC address, and
the information equipment control unit receives the MAC address from the information equipment to extract the product ID corresponding to the MAC address from the user identification database, extract the URL of the first server corresponding to the MAC address from the product list database, and request a software version corresponding to the product ID to the first server indicated by the URL.

6. The system according to claim 5 further comprising,
a user basic information database that stores a user ID to identify the user and an IP address of the terminal device corresponding to the user ID, and
a terminal process unit that requests the update request of the information equipment to the terminal device, wherein
the user identification database in the second server stores the MAC address of the information equipment and the user ID to identify the user corresponding to the MAC address, and
the terminal process unit refers to the user identification database by using the MAC address as a key to extract the user ID, extract the IP address of the terminal device from the user basic information database by using the extracted user ID as a key, and request the update request of the information equipment to the terminal device indicated by the IP address.

7. The system according to claim 2 wherein
the terminal device includes an update information acquiring unit that stores the update request of the information equipment received the update request and a screen display unit that displays contents, stored in the update information acquiring unit, of the update request of the information equipment.

8. The system according to claim 7 wherein
the terminal device displays information of an update notification on the screen display unit to thereby display an input screen of an authentication key for authenticating that a user is right and transmit an update permission notification of the software including the authentication key entered from the user to the second server, when the user enters the authentication key.

9. The system according to claim 2 wherein
the information equipment includes a MAC address notification unit that notifies a MAC address allotted to the information equipment itself to the second server, a software storage unit that stores a software received from the second server, and a software process unit that executes an update processing of the received software.

10. The system according to claim 9 wherein
the information equipment provides an IP address acquiring unit that acquires an IP address from the second server,
the MAC address notification unit notifies the MAC address to the second server, and
the IP address acquiring unit that acquires the IP address distributed from the second server.

11. The system according to claim 10 wherein
the second server includes a DHCP server-use database that stores a correspondence of the IP address and the MAC address, an IP address distribution unit that selects the IP address to be distributed to the information equipment from the DHCP server-use database, and a service control unit that receives a MAC address notification from the information equipment, and
the IP address distribution unit selects the IP address not allotted to other information equipment from the DHCP server-use database to be distributed to the information equipment that sent the MAC address notification.

12. An update server for updating a software in an information equipment comprising
a user identification database that stores a user ID that identifies a user of the information equipment, a MAC address of the information equipment corresponding to the user ID, and a product ID to identify a product model number of the information equipment corresponding to the MAC address, and
a user basic information database that stores the user ID, and an IP address of a terminal device corresponding to the user ID, wherein
the user ID is extracted from the user identification database by using the MAC address received from the information equipment as a key, to transmit a software update notification to the terminal device indicated by the IP address acquired from the user basic information database by using the extracted user ID as a key.

13. The update server according to claim 12 further comprising,
a product list database that stores the MAC address of the information equipment and a URL of an update data server having a software corresponding to the MAC address, wherein a software request message containing an authentication key is transmitted to the update data server, when an update permission notification of the software containing the authentication key for proving that a user is right, is received from the terminal device, and
a service control unit that transmits an update-use software replied from the update data server to the information equipment.

14. The update server according to claim 13 further comprising,
an information equipment control unit that requests a software version to the information equipment, wherein
the service control unit requests the software version to the update data server storing the software version to compare the software version acquired from the information equipment with the software version acquired from the update data server and transmit the software update notification corresponding to the product ID to the terminal device corresponding to the user ID, when the software version acquired from the update data server is newer than that from the information equipment.

15. The update server according to claim 14 further comprising,
a DHCP server-use database that stores the IP address distributed to the information equipment and the MAC address of the information equipment corresponding to the IP address, and
an IP address distribution unit that selects the IP address not distributed to other information equipment from the DHCP server-use database to be distributed to the information equipment.
